(19) United States
(12) Patent Application Publication
(10) Pub. No.: US 2023/0419210 A1
(43) Pub. Date: Dec. 28, 2023

(54) ESTIMATING A NUMBER OF PEOPLE AT A POINT OF INTEREST USING VEHICLE SENSOR DATA AND GENERATING RELATED VISUAL INDICATIONS

(71) Applicant: Microsoft Technology Licensing, LLC, Redmond, WA (US)

(72) Inventors: Leon Oliver STENNETH, Chicago, IL (US); Catalin Bogdan CAPOTA, Chicago, IL (US)

(73) Assignee: Microsoft Technology Licensing, LLC, Redmond, WA (US)

(21) Appl. No.: 17/871,543

(22) Filed: Jul. 22, 2022

Related U.S. Application Data
(63) Continuation of application No. 17/851,928, filed on Jun. 28, 2022.

(51) Int. Cl. G06Q 10/06

(52) U.S. Cl. CPC G06Q 10/06313

(57) ABSTRACT

Methods and systems for estimating a number of people at a point of interest using vehicle data are provided. In some examples, vehicle data is received, from a plurality of vehicles, that corresponds to a geographic boundary encompassing a point of interest. From the vehicle data, a first subset of data corresponding to door sensor information is extracted. Based on the first subset of data, an estimated number of people within the geographic boundary, during a specified period of time, is determined. An indication corresponding to the estimated number of people within the geographic boundary is generated.

### PRIORITY

This application is a continuation of, and claims priority to, U.S. patent application Ser. No. 17/851,928, filed Jun. 28, 2022, and entitled “ESTIMATING A NUMBER OF PEOPLE AT A POINT OF INTEREST USING VEHICLE SENSOR DATA AND GENERATING RELATED VISUAL INDICATIONS,” which is hereby incorporated by reference, in its entirety.

### BACKGROUND

A point of interest (POI) may be a concert hall, a conference hall, a stadium, a restaurant, a hotel, a park, a residential home, etc. Estimating the number of people at a POI can be important for safety, travel logistics, and/or map visualization.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for estimating a number of people at a point of interest (POI) using vehicle sensor data. Further, aspects of the present disclosure relate to methods, systems, and media for generating visual indications corresponding to an estimated number of people at a POI.

In some examples, a method is provided. The method includes receiving vehicle data, from a plurality of vehicles, corresponding to a geographic boundary encompassing a point of interest, extracting, from the vehicle data, a first subset of data corresponding to door sensor information, determining, based on the first subset of data, an estimated number of people within the geographic boundary, during a specified period of time, and generating an indication corresponding to the estimated number of people within the geographic boundary.

Some examples further include training a machine learning model to count a number of passengers leaving vehicles, based on a training set of vehicle data and a ground truth set of data. The ground truth set of data corresponds to an observed actual number of passengers leaving vehicles. The determining of the estimated number of people within the geographic boundary includes inputting the first subset of data into the trained machine learning model, and receiving, from the trained machine learning model, the estimated number of people within the geographic boundary.

In some examples, the door sensor information includes one or more of: a number of doors open on a vehicle, a duration of which each of the doors are open, and a duration of which the vehicle is stopped.

Some examples further include extracting, from the vehicle data, a second subset of data corresponding to a change in seatbelt status. The determining of the estimated number of people within the geographic boundary is further based on the second subset of data.

In some examples, the point of interest is one of a venue, a restaurant, a hotel, or a park.

In some examples, the vehicle data is vehicle sensor data that is received in real time.

In some examples, the geographic boundary is a pre-determined range about the point of interest.

In some examples, a method is provided. The method includes receiving vehicle data that correspond to a plurality of geographic boundaries that correspond to a point of interest, extracting, from the vehicle data, a first subset of data corresponding to door sensor information, determining, based on the door sensor information, an estimated number of people within the plurality of geographic boundaries, during a specified period of time, and generating an indication corresponding to the estimated number of people within the plurality of geographic boundary.

In some examples, the plurality of geographic boundaries comprise one or more segments of roads and building footprint data.

In some examples, the building footprint data defines a perimeter of the point of interest, and the one or more segments of roads are associated with the point of interest.

In some examples, the plurality of geographic boundaries comprise a first boundary that corresponds to a first set of vehicle data and a second boundary that corresponds to a second set of vehicle data. The first set of vehicle data is different than the second set of vehicle data, and the first and second sets of vehicle data are subsets of the vehicle data.

Some examples further include receiving historical data corresponding to transit data, biking data, and pedestrian data for a point of interest, and updating the estimated number of people within the plurality of geographic boundaries, based on the historical data.

Some examples further include extracting, from the vehicle data, a second subset of data that corresponds to a change in seatbelt status. The determining of the estimated number of people within the geographic boundary is further based on the second subset of data.

In some examples, a method is provided. The method includes receiving vehicle data corresponding to one or more geographic boundaries, extracting, from the vehicle data, a first subset of data corresponding to a change in seatbelt status, determining, based on the first subset of data, an estimated number of people within the one or more geographic boundaries, during a specified period of time, and generating an indication corresponding to the estimated number of people within the one or more geographic boundaries.

Some examples further include extracting, from the vehicle data, a second subset of data corresponding to door sensor information. The determining of the estimated number of people within the one or more geographic boundaries is further based on the second subset of data.

In some examples, each of the one or more geographic boundaries are pre-determined corresponding to one or more points of interest.

In some examples, a method is provided. The method includes receiving a first estimated number of people who have exited vehicles within a geographic boundary, receiving a capacity for a point of interest corresponding to the geographic boundary, calculating a capacity index, the capacity index being a ratio of the first estimated number of people to the capacity, generating a first visual indicator, based on the capacity index, and displaying the first visual indicator on a map, based on a location of the point of interest.

Some examples further include receiving a second estimated number of people within the geographic boundary, calculating a second capacity index, the second capacity index being a ratio of the second estimated number of people to the capacity, generating a second visual indicator, based on the second capacity index, and replacing the first visual indicator, on the map, with the second visual indicator.

In some examples, the first visual indicator is a first icon that includes a first color and the second visual indicator is a second icon that includes a second color.

Some examples further include receiving a third estimated number of people within the geographic boundary, calculating a third capacity index, the third capacity index being a ratio of the third estimated number of people to the capacity, re-generating the first visual indicator, based on the third capacity index, and replacing the second visual indicator, on the map, with the first visual indicator.

Some examples further include receiving a third estimated number of people within the geographic boundary, calculating a third capacity index, the third capacity index being a ratio of the third estimated number of people to the capacity, generating a third visual indicator, based on the third capacity index, and replacing the second visual indicator, on the map, with the third visual indicator.

In some examples, the third visual indicator is a third icon that includes a third color.

In some examples, the first visual indicator corresponds to the capacity index being less than a first threshold.

In some examples, the second visual indicator corresponds to the capacity index being greater than the first threshold and less than a second threshold.

In some examples, the third visual indicator corresponds to the capacity index being greater than the second threshold.

In some examples, each of the first threshold, second threshold, and third threshold are configurable values.

In some examples, the capacity is a pre-defined number of people that can be located at the point of interest based on one or more of: a safety policy or physical space limitations.

In some examples, a method is provided. The method includes receiving a first estimated number of people, outside of vehicles, corresponding to a first point of interest, receiving a second estimated number of people, outside of vehicles, corresponding to a second point of interest, receiving a first capacity for the first point of interest and a second capacity for the second point of interest, calculating a first capacity index for the first point of interest and a second capacity index for the second point of interest, and generating a first indicator, based on the first capacity index, and a second indicator, based on the second capacity index.

In some examples, the first capacity index is a ratio of the first estimated number of people to the first capacity, and the second capacity index is a ratio of the second estimated number of people to the second capacity.

In some examples, the first and second indicators are audio indicators.

Some examples further include displaying the first and second visual indicators on a map.

In some examples, a method is provided. The method includes receiving an estimated number of people, outside of vehicles, within one or more geographic boundaries, receiving a capacity for a point of interest corresponding to the one or more geographic boundaries, and calculating a capacity index. The capacity index is a ratio of the estimated number of people to the capacity. The method further includes generating a visual indicator, based on the capacity index. The estimated number of people, the capacity index, and the visual indicator are updated periodically.

In some examples, if the capacity index is greater than a pre-determined threshold, the generated visual indicator is a first visual indicator.

In some examples, if the capacity index is less than a pre-determined threshold, the generated visual indicator is a second visual indicator.

In some examples, the estimated number of people within the geographic boundary is calculated based on vehicle data.

In some examples, a system is provided. The system includes at least one processor and memory storing instructions that, when executed by the at least one processor, causes the system to perform any of the example methods described above.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates a detailed schematic of a portion of the example system of FIG. 1 according to some aspects described herein.

FIG. 3 illustrates a detailed schematic of a portion of the example system of FIG. 1 according to some aspects described herein.

FIG. 4 illustrates a detailed schematic of a portion of the example system of FIG. 1 according to some aspects described herein.

FIG. 5 illustrates an example use-case of mechanisms described herein.

FIG. 6 illustrates an example use-case of mechanisms described herein.

FIG. 7 illustrates an example method of estimating a number of people corresponding to a point of interest, according to some aspects described herein.

FIG. 8 illustrates example indicators of a number of people corresponding to a point of interest, according to some aspects described herein.

FIG. 9 illustrates an example method of generating an indicator of an estimated number of people corresponding to a point of interest, according to some aspects described herein.

FIG. 10 is a block diagram illustrating example physical components of a computing device with which aspects of the disclosure may be practiced.

FIGS. 11A and 11B are simplified block diagrams of a mobile computing device with which aspects of the present disclosure may be practiced.

FIG. 12 is a simplified block diagram of a distributed computing system in which aspects of the present disclosure may be practiced.

FIG. 13 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The evolution of cloud computing technology has significantly increased the amount of computations that are able to be performed remotely. Some examples of computations that may be performed on one or more remote servers (e.g., the cloud) include mapping and population estimation algorithms. In some examples, mapping algorithms may be relied upon for commercial transportation, as well as by everyday individuals looking to get from a first location (e.g., a home, school, grocery store, social event, errand, etc.) to a second location (e.g., a home school, grocery store, social event, errand, etc.). Further, in some examples, mapping algorithms and population estimation algorithms may be used by venues and/or safety officials to prepare for evacuations, inclement weather procedures, or other emergency and/or safety protocols that are designed to protect the safety and well-being of individuals at a point of interest.

Concurrent to the evolution of cloud computing technology, vehicles (e.g., cars, trucks, buses, etc.) are being manufactured with an increasing number of sensors. Modern vehicles may include sensors for a number of doors that are open, which of a plurality of doors are open, a duration for which a vehicle door is open, a speed of a vehicle, a duration for which a vehicle is stopped, a change in a seatbelt status, weather, a number of seats that are occupied, which door handle is operated (e.g., an inner door handle or an outer door handle), one or more cameras, etc. Additional, and/or alternative, sensors or equipment that may be found in modern-day vehicles may be recognized by those of ordinary skill in the art.

As mentioned above, estimating the number of people at a POI can be important for safety, travel logistics, and/or map visualization. Typically, a point of interest such as a restaurant or hotel may be able to estimate the number of people located thereat, using reservation data. In another example, a venue such as a concert hall, stadium, or conference hall may be able to estimate the number of people located thereat using ticket data (e.g., how many tickets were sold, scanned, or collected prior to an event located at the venue). However, reservation data and ticket data may not be readily available to organizations that manage mapping software.

Accordingly, one or more drivers who are planning trips, by relying on mapping software, may be unable to consider potential traffic, based on an estimated number of people at a point of interest that the one or more drivers may be travelling through or nearby. For example, if a driver were to be travelling through a major city, during a major sporting event or other type of event occurring in the city, it may have been beneficial for the driver to know where crowds are forming, from or around points of interest, based on mapping software, such that the driver could avoid potential traffic, and make it home in time for dinner.

As another example, emergency services, such as firefighters, paramedics, etc., that rely on population information at points of interest, for emergency protocols (e.g., severe weather, evacuations, etc.), may be unable to receive accurate population estimations, in real time. Therefore, for example, if inclement weather were to occur at an outdoor music festival (e.g., an event) occurring in a park (e.g., a point of interest at which the event is occurring), the emergency services may be able to more effectively evacuate people to nearby storm shelters, based on real-time population data generated by mapping software.

As yet another example, a customer may decide whether or not to make a reservation at a restaurant (e.g., a point of interest), depending on how many people are at the restaurant. Therefore, if a customer could be notified, such as via a mapping software, that there are a relatively large amount of people at a restaurant, they may decide not to make a reservation or not travel to the restaurant. Conversely, if a customer could be notified, such as via a mapping software, that there are relatively few people at the restaurant, they may decide to make a reservation or travel to the restaurant.

Accordingly, some aspects of the present disclosure relate to methods, systems, and media for estimating a number of people at a point of interest (POI) using vehicle sensor data. Generally, vehicle data may be received that corresponds to one or more geographic boundaries that correspond to a point of interest. A first subset of data (e.g., door sensor information, weather information, seatbelt information, etc.) may be extracted from the vehicle data. Based on the first subset of data, an estimated number of people may be determined within the one or more geographic boundaries. An indication may be generated that corresponds to the estimated number of people within the geographic boundary.

Further, some aspects of the present disclosure relate to methods, systems, and media for generating visual indications corresponding to an estimated number of people at a POI. Generally, an estimated number of people may be received within one or more geographic boundaries corresponding to a point of interest. A capacity for the point of interest may be received. A capacity index may be calculated, as a ratio of the estimated number of people to the received capacity. Further, an indicator may be generated based on the capacity index. The estimated number of people, the capacity index, and the indicator may be updated periodically (e.g., every 15 minutes) to provide real-time indications of an estimated number of people at the POI.

Advantages of mechanisms disclosed herein may include an improved ability to estimate the number of people at a point of interest (e.g., in real time), using real time vehicle sensor data. Further advantages may include improved user engagement through a more specific user-interface that provides indications of the number of people at a point of interest (e.g., in real time). Further advantages may be apparent to those of ordinary skill in the art, at least in light of the non-limiting examples described herein.

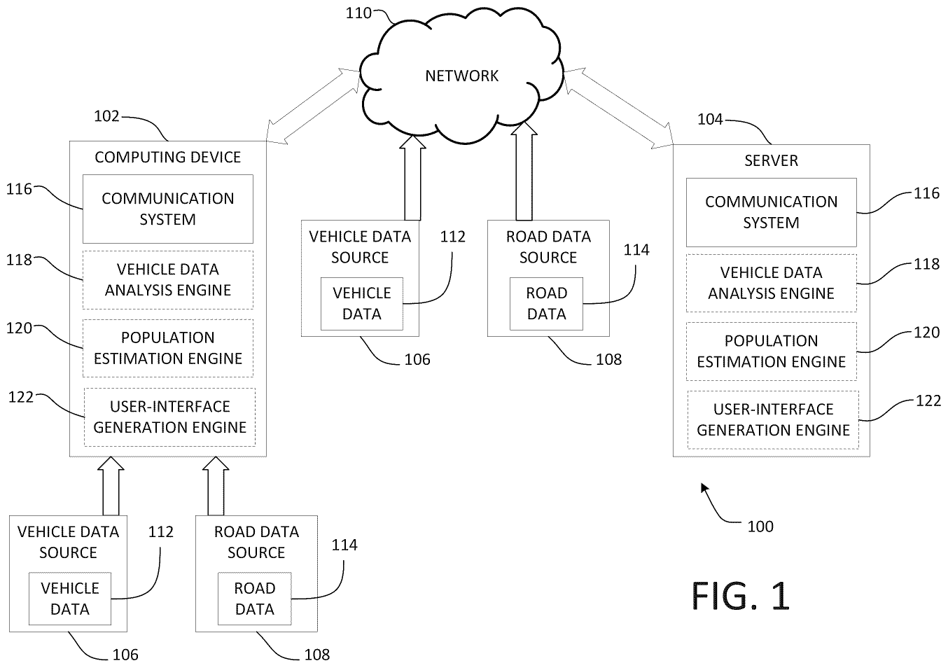

FIG. 1 shows an example of a system 100, in accordance with some aspects of the disclosed subject matter. The system 100 may be a system for estimating the number of people at a point of interest (e.g., in real time). Additionally, or alternatively, the system 100 may be a system for generating visual indications (e.g., via a user-interface) corresponding to an estimated number of people at a point of interest (e.g., in real time). The system 100 includes one or more computing devices 102, one or more servers 104, a vehicle data source 106, a road data source 108, and a communication network or network 110. The computing device 102 can receive vehicle data 112 (e.g., vehicle sensor data) from the vehicle data source 106, which may be, for example a vehicle (e.g., a car, truck, bus, autonomous vehicle, gas vehicle, electric vehicle, hybrid vehicle, etc.) that transmits vehicle data, a computer-executed program that generates vehicle data, and/or memory with data stored therein corresponding to vehicle data. The vehicle data 112 may include speed data, direction data, location data, time data, battery data, fuel level data, door sensor data, seat data, seatbelt data, weather data (e.g., from an in-vehicle thermometer or other weather-related sensor), and/or other vehicle sensor data that may be recognized by those of ordinary skill in the art.

Additionally, or alternatively, the network 110 can receive vehicle data 112 from the vehicle data source 106, which may be, for example a vehicle (e.g., a car, truck, bus, autonomous vehicle, gas vehicle, electric vehicle, hybrid vehicle, etc.) that transmits vehicle data, a computer-executed program that generates vehicle data, and/or memory with data stored therein corresponding to vehicle data. The vehicle data 112 may include speed data, direction data, location data, windshield wiper sensor data, time data, battery data, fuel level data, door sensor data, seat data, seatbelt data, weather data (e.g., from an in-vehicle thermometer or other weather-related sensor), and/or other vehicle sensor data that may be recognized by those of ordinary skill in the art.

Further, the computing device 102 can receive road data 114 from the road data source 108, which may be, for example, a service that provides road data, a computer-executable program that generates road data, and/or memory with data stored therein corresponding to road data. The road data 114 may include information corresponding to the geographic location of one or more roads, geographic locations of points of interest (e.g., relative to one or more roads), an elevation of one or more roads (e.g., if a road includes a bridge, if two or more roads overlay each other, etc.), one or more different types of roads, such as highways, tollways, alleyways, local roads, country roads, etc. Road data may include building foot print data, building entrance information, etc. Additional, and/or alternative, road data may be recognized by those of ordinary skill in the art.

Additionally, or alternatively, the network 110 can receive road data 114 from the road data source 108, which may be, for example, a service that provides road data, a computer-executable program that generates road data, and/or memory with data stored therein corresponding to road data. The road data 114 may include information corresponding to the geographic location of one or more roads, geographic locations of points of interest (e.g., relative to one or more roads), an elevation of one or more roads (e.g., if a road includes a bridge, if two or more roads overlay each other, etc.), one or more different types of roads, such as highways, tollways, alleyways, local roads, country roads, etc. Additional, and/or alternative, road data and how to obtain such road data may be recognized by those of ordinary skill in the art.

It should be recognized by those of ordinary skill in the art that geographic boundaries may be generated using a plurality of systems and methods. For example, a geographic boundary may be generated based on a plurality of vehicles that let people out/in from the vehicles along portions of one or more roads. The portions of the one or more roads may be determined to be within the geographic boundary. Additionally, or alternatively, a geographic boundary may include building footprint data, such as in examples where a point of interest to which a geographic boundary corresponds is a building that has a perimeter defined by building footprint data. Road data may be associated with the building footprint data, such as in instances where a road is adjacent to, or otherwise associated with, a building. In some examples, geographic boundaries may be predefined based on road data and/or building footprint data. Additionally, or alternatively, in some examples, geographic boundaries may be automatically generated based on vehicle data that is received, and that may, in some instances, correspond to road data and/or building footprint data.

Computing device 102 may include a communication system 116, a vehicle data analysis engine or component 118, a population estimation engine or component 120, and/or a user-interface generation engine or component 122. In some examples, computing device 102 can execute at least a portion of the vehicle data analysis component 118 to collect and/or analyze data from one or more vehicle sensors, such as data corresponding to a number of doors open on a vehicle, a duration for which a vehicle door is open, a duration for which a vehicle is stopped, a change in seatbelt status, weather, a number of seats that are occupied, etc. Further, in some examples, computing device 102 can execute at least a portion of the population estimation component 120 to identify a point of interest, identify one or more roads, generate one or more geographic boundaries, and/or determine an estimated number of people within each of the one or more geographic boundaries, corresponding to the point of interest. Further, in some examples, computing device 102 can execute at least a portion of user-interface component 122 to generate a map, calculate a capacity index corresponding to a point of interest, generate an indication corresponding to the capacity index, and update a user-interface based on the indication.

Server 104 may include a communication system 116, a vehicle data analysis engine or component 118, a population estimation engine or component 120, and/or a user-interface generation engine or component 122. In some examples, server 104 can execute at least a portion of the vehicle data analysis component 118 to collect and/or analyze data from one or more vehicle sensors, such as data corresponding to a number of doors open on a vehicle, a during for which a vehicle door is open, a duration for which a vehicle is stopped, a change in seatbelt status, weather, a number of seats that are occupied, etc. Further, in some examples, server 104 can execute at least a portion of the population estimation component 120 to identify a point of interest, identify one or more roads, generate one or more geographic boundaries, and/or determine an estimated number of people within each of the one or more geographic boundaries, corresponding to the point of interest. Further, in some examples, server 104 can execute at least a portion of user-interface component 122 to generate a map, calculate a capacity index corresponding to a point of interest, generate an indication corresponding to the capacity index, and update a user-interface based on the indication.

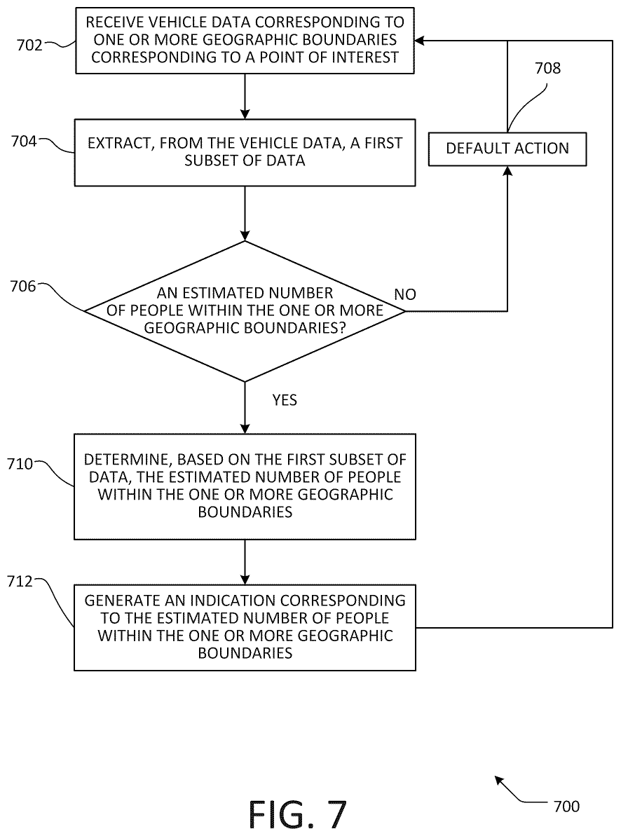

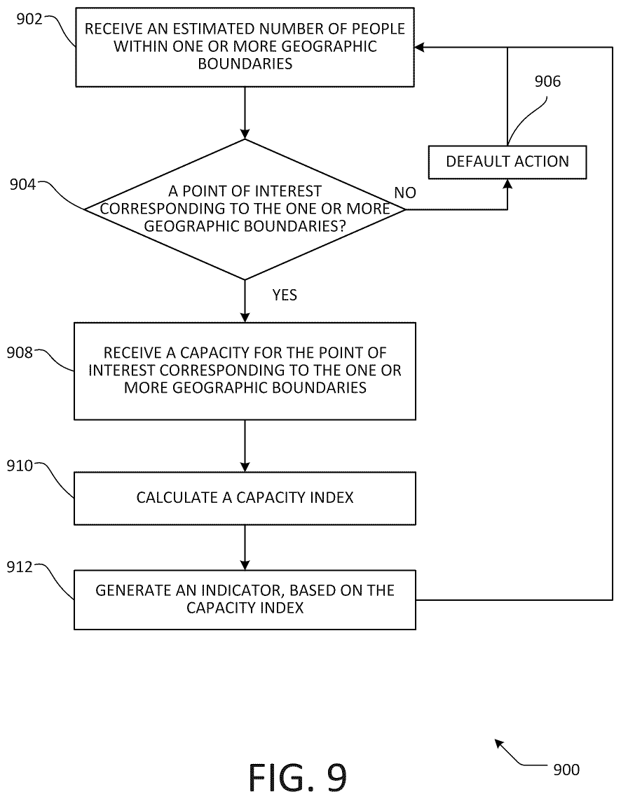

Additionally, or alternatively, in some examples, computing device 102 can communicate data received from vehicle data source 106 and/or road data source 108 to the server 104 over a communication network 110, which can execute at least a portion of vehicle analysis data component 118, population estimation component 120, and/or user-interface generation component 122. In some examples, vehicle data analysis component 118 may execute one or more portions of methods/processes 700 and/or 900 described below in connection with FIGS. 7 and 9, respectively. Further, in some examples, population estimation component 120 may execute one or more portions of methods/processes 700 and/or 900 described below in connection with FIGS. 7 and 9, respectively. Further, in some examples, user-interface generation component 122 may execute one or more portions of methods/processes 700 and/or 900 described below in connection with FIGS. 7 and 9, respectively.

In some examples, computing device 102 and/or server 104 can be any suitable computing device or combination of devices that may be used by a requestor, such as a desktop computer, a vehicle computer (e.g., an infotainment system), a laptop computer, a smartphone, a tablet computer, a wearable computer, a server computer, a virtual machine being executed by a physical computing device, a web server, etc. Further, in some examples, there may be a plurality of computing device 102 and/or a plurality of servers 104.

In some examples, vehicle data source 106 can be any suitable source of vehicle data (e.g., sensor data generated from one or more sensors of a vehicle, vehicle data recorded by a user, vehicle data obtained from a database of aggregated information from one or more vehicles, etc.). In a more particular example, vehicle data source 106 can include memory storing vehicle data (e.g., local memory of computing device 102, local memory of server 104, cloud storage, portable memory connected to computing device 102, portable memory connected to server 104, etc.).

In another more particular example, vehicle data source 106 can include an application configured to generate vehicle data. In some examples, vehicle data source 106 can be local to computing device 102. Additionally, or alternatively, vehicle data source 106 can be remote from computing device 102 and can communicate vehicle data 112 to computing device 102 (and/or server 104) via a communication network (e.g., communication network 110).

In some examples, road data source 108 can be any suitable source of road data (e.g., a government, corporate, or other type of data store containing road data). In a more particular example, road data source 108 can include memory storing road data (e.g., local memory of computing device 102, local memory of server 104, cloud storage, portable memory connected to computing device 102, portable memory connected to server 104, etc.).

In another more particular example, road data source 108 can include an application configured to generate road data. In some examples, road data source 108 can be local to computing device 102. Additionally, or alternatively, road data source 108 can be remote from computing device 102 and can communicate road data 114 to computing device 102 (and/or server 104) via a communication network (e.g., communication network 110).

In some examples, communication network 110 can be any suitable communication network or combination of communication networks. For example, communication network 110 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 110 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

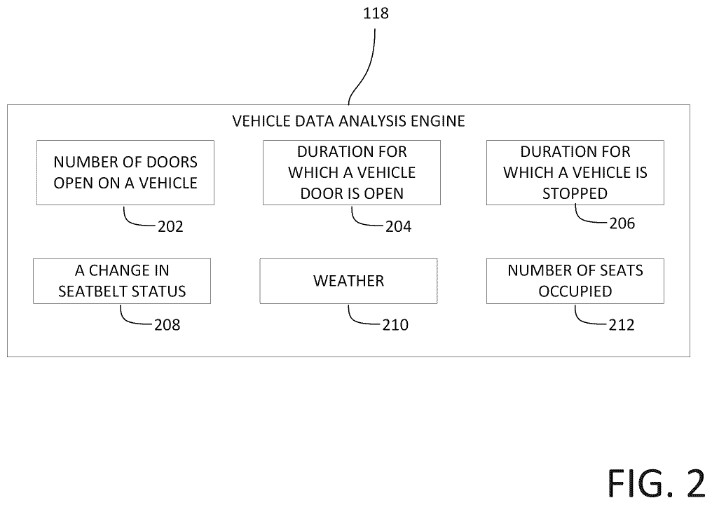

FIG. 2 illustrates a detailed schematic of the vehicle data analysis component or engine 118 of the example system 100. The vehicle data analysis component 118 includes a plurality of components or engines that implement various aspects of the vehicle data analysis component 118. For example, the vehicle data analysis component 118 can include a number of doors open on a vehicle component 202, a duration for which a vehicle door is open component 204, a duration for which a vehicle is stopped component 206, a change in seatbelt status component 208, a weather component 210, and a number of seats occupied component 212. The plurality of components of the vehicle data analysis engine 118 may store information that is parsed or otherwise determined from vehicle data (e.g., vehicle data 112).

The number of doors open on a vehicle component 202 may contain (e.g., stored in a memory location corresponding to the number of doors open on a vehicle component 202), and/or generate an indication of a number of doors open on one or more vehicles (e.g., a single vehicle, or each of a plurality of vehicles). For example, a vehicle may include a first door or driver-side front door, a second door or passenger-side front door, a third door or driver-side rear door, a fourth door or passenger-side rear door, a fifth door or trunk door, and/or a sixth door or hood of vehicle. Additional and/or alternative doors (e.g., components of a vehicle body that open and close) that may be part of a vehicle may be recognized by those of ordinary skill in the art. The number of doors open on a vehicle may count, based on data received from a plurality of door sensors, how many doors are open on a vehicle.

Generally, if one or more users are exiting a vehicle, it may be beneficial to know how many of the vehicle's doors, and in some examples, which of the vehicle's doors are open (e.g., based on data from which of a plurality of sensors corresponding to a door being open was received), to calculate how many users are exiting the vehicle. Therefore, in some examples, data corresponding to the trunk door or the hood of a vehicle being opened may be filtered out of the number of doors open on a vehicle component 202 because people may not exit vehicles from the trunk door or hood of the vehicle. Likewise, data corresponding to the first door, the second door, the third door, and the fourth door may be extracted as a subset of data, for further processing to be performed thereon. As another example, if a vehicle is determined to be a commuter vehicle (e.g., a bus) or a ride share vehicle, then data corresponding to the front driver-side door may be filtered out because it may be assumed that the driver is only dropping off passengers, and not exiting the vehicle.

The duration for which a vehicle door is open component 204 may contain (e.g., stored in a memory location corresponding to the duration for which a vehicle door is open component 204), and/or generate an indication of a duration for which a vehicle door is open on one or more vehicles (e.g., a single vehicle, or each of a plurality of vehicles). For example, if a vehicle door is open for a relatively short duration of time, then it may be determined that relatively few people exited through the door (e.g., one person, in a vehicle that supports three passengers who may exit through the same door). Alternatively, if a vehicle door is open for a relatively long duration of time, then it may be determined that relatively many people exited through the door (e.g., three people, in a vehicle that supports three passengers who may exit through the same door). Accordingly, the duration for which a vehicle door is open may be a time value (e.g., in seconds, minutes, etc.) that is received based on the duration between two state changes of a vehicle door (e.g., from an open position to a closed position), based on sensors of a vehicle.

The duration for which a vehicle is stopped component 206 may contain (e.g., stored in a memory location corresponding to the duration for which a vehicle is stopped component 206), and/or generate an indication of a duration for which a vehicle is stopped (e.g., a single vehicle, or each of a plurality of vehicles). For example, if a vehicle is stopped for a relatively short duration of time, then it may be determined that relatively few people exited through the door (e.g., one person, in a vehicle that supports three passengers who may exit through the same door). Alternatively, if a vehicle is stopped for a relatively long duration of time, then it may be determined that relatively many people exited through the door (e.g., three people, in a vehicle that supports three passengers who may exit through the same door). Accordingly, the duration for which a vehicle is stopped may be a time value (e.g., in seconds, minutes, etc.) that is received based on speedometer data or other speed/location data collected from a vehicle, taken over a period of time.

The change in seat belt status component 208 may contain (e.g., stored in a memory location corresponding to the change in seat belt status component 208), and/or generate an indication of a change in seatbelt status for one or more vehicles (e.g., a single vehicle, or each of a plurality of vehicles). For example, one or more seatbelts within a vehicle may include seatbelt sensors that indicate whether or not a seatbelt is clipped into a seatbelt holder (e.g., the seatbelt is fastened, or the seatbelt is on). If a seatbelt goes from a first state or fastened state to a second state or unfastened state, then it may be indicative a person getting out of a vehicle. Alternatively, if a seatbelt goes from the second state or unfastened state to the first state or fastened state, then it may be indicative of a person getting into the vehicle. Accordingly, a number of people who are exiting a vehicle to a point of interest, or exiting a point of interest to a vehicle, may be determined (or at least estimated) based on a status or state change of one or more seatbelts within one or more vehicles (e.g., based on seatbelt sensors within the one or more vehicles).

The weather component 210 may contain (e.g., stored in a memory location corresponding to the weather component 210), and/or generate an indication of weather around one or more vehicles (e.g., a single vehicle, or each of a plurality of vehicles). For example, a vehicle may include a thermometer that reads temperature around a vehicle. Depending on the temperature around the vehicle, people may be slower or faster at entering or exiting a vehicle. Additionally, or alternatively, each of the one or more vehicles may include a humidity sensor to receive humidity information that affects a speed at which one or more users exit or enter the one or more vehicles.

Additionally, or alternatively, each of the one or more vehicles may receive, store, or generate other weather information (e.g., precipitation, wind, cloud coverage, etc.) from one or more computing device within the vehicle (e.g., a sensor, smartphone, infotainment system, etc.) that may impact a speed at which one or more users exit or enter a vehicle. In some examples, if it is cold and raining outside, then a user may leave a vehicle (e.g., as determined based on a seatbelt being taken off, and a door being opened from the inside), relatively slowly (e.g., because they are not eager to be in the cold rain). On the other hand, if it is cold and raining outside, then a user may enter a vehicle (e.g., as determined by a door being opened from the outside, and a seatbelt subsequently being put on), relatively quickly (e.g., because they are eager to get out of the cold rain).

The number of seats occupied component 212 may contain (e.g., stored in a memory location corresponding to the number of seats occupied component 212), and/or generate an indication of a number of seats that are occupied in one or more vehicles (e.g., a single vehicle, or each of a plurality of vehicles). For example, a vehicle may include seat sensors (e.g., weight sensors) corresponding to one or more seats in the vehicle. The seat sensors may change between a first state or occupied state to a second state or empty state based on if a seat corresponding to the seat sensor is occupied or empty. If a seat goes from being occupied to being empty (e.g., as determined based on information from the seat sensors), then a user may be exiting the vehicle. Alternatively, if a seat goes from being empty to being occupied (e.g., as determined based on information from the seat sensors), then a user may be entering the vehicle. Therefore, a number of seats that are occupied (e.g., as determined based on seat sensors), and/or a change in a number of seats that are occupied, may help to determine how many people are entering or exiting one or more vehicles at or near a particular POI.

Generally, the vehicle data analysis component 118 collects, stores, and/or analyzes vehicle data (e.g., vehicle data 112) that may be gathered from a plurality of vehicles sensors, such as a number of doors open on a vehicle, a duration for which a vehicle door is open, a duration for which a vehicle is stopped, a change in seatbelt status, weather, and a number of seats that are occupied. The vehicle data analysis component 118 may help to collect, store, and/or analyze vehicle data to predict how many people are entering or exiting a vehicle (e.g., at a point of interest and/or within specified geographic boundaries). Additional, and/or alternative vehicle data that may be useful to collect, store, or analyze, such as to assist in predicted a number of people entering or exiting the vehicle, may be recognized by those of ordinary skill in the art.

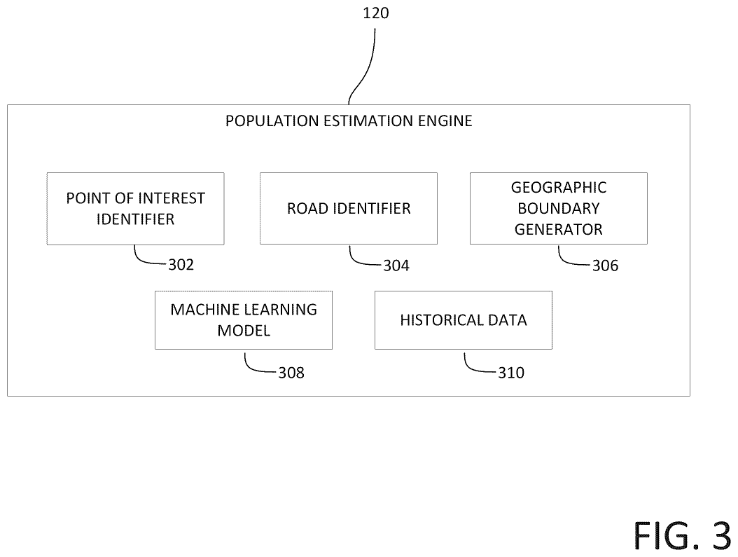

FIG. 3 illustrates a detailed schematic of the population estimation engine or component 120 of the example system 100. The population estimation component 120 includes a plurality of components or engines that implement various aspects of the population estimation component 120. For example, the population estimation component 120 can include a point of interest identifier component 302, a road identifier component 304, a geographic boundary generator component 306, and/or a machine learning model component 308.

The point of interest identifier component 302 may contain (e.g., stored in a memory location corresponding to the point of interest identifier component 302), and/or generate an indication of a point of interest. For example, the point of interest (“POI”) may be a location such as a concert hall, a conference hall, a stadium, a restaurant, a hotel, a park, a residential building, a street or portion thereof, etc. Additionally, or alternatively, the POI may refer to any location that one or more people may find to be useful or interesting. Therefore, additional examples of points of interest may be recognized by those of ordinary skill in the art.

The point of interest identifier component 302 may receive (e.g., from a user, or a device) a location (e.g., geographic coordinates, a street address, etc.) corresponding to a point of interest. Additionally, or alternatively, the point of interest identifier component 302 may receive (e.g., from a user, or a device) a title of a point of interest, and the point of interest identifier component 302 may determine, based on the title of the point of interest, and in some examples a context in which the title was provided, a location of the point of interest. The point of interest may be previously determined, e.g., stadiums, theaters, etc. or the point of interest may be dynamically determined, e.g., if a significant number of people are determined to be exiting vehicles near an otherwise previously unrecognized point, then a new point of interest may be created and stored for current and future use.

The road identifier component 304 may contain (e.g., stored in a memory location corresponding to the road identifier component 304), and/or generate an indication of one or more roads corresponding to a point of interest. The one or more roads corresponding to the point of interest may be based on road data (e.g., road data 114, discussed earlier herein with respect to road data source 108 of FIG. 1). A point of interest may have one or more roads that lead up to the point of interest. Additionally, or alternatively, a point of interest may have one or more roads that surround, are nearby, or are otherwise associated with a point of interest. In some examples, the one or more roads may be road along which vehicles drop people off or pick people up that are going to the point of interest. In some examples, the one or more roads may be roads along which vehicles are parked, such that individuals within the vehicles can go to the point of interest.

The road identifier component 304 may receive (e.g., from a user, or a device) one or more roads, or portions thereof, (e.g., geographic coordinates, a road names, mile markers, etc.) that correspond to a point of interest (e.g., along which vehicles may drop-off people, pick-up people, or park for people to get-in/get-out when going to a point of interest). Additionally, or alternatively, the road identifier component 304 may receive (e.g., from a user, or a device) a point of interest, and the road identifier component 304 may determine, based on road data (e.g., road data 114), one or more roads, or portions thereof, that correspond to the point of interest.

The geographic boundary generator component 306 may contain (e.g., stored in a memory location corresponding to the geographic boundary generator component 306), and/or generate an indication of one or more geographic boundaries corresponding to a point of interest. The one or more geographic boundaries may generated be based on road data (e.g., road data 114). For example, if the point of interest is a stadium, then a geographic boundary may be defined around the legal perimeter of the stadium (e.g., as determined based on property records, building footprints, building data collected from Lidar enabled vehicles, and/or based on land corresponding to the stadium located between roads and/or nearby addresses).

Additionally, or alternatively, in some examples the one or more geographic boundaries may be predetermined corresponding to one or more points of interest. For example, a user may define a geographic boundary around the point of interest using one or more polygonal or non-polygonal shapes. Additionally, or alternatively, a user may define a geographic boundary around a parking lot (e.g., of a stadium) corresponding to a point of interest, and that does not include the point of interest (e.g., the stadium itself), because vehicles may not be allowed to enter the point of interest, and therefore vehicle data may not be collected (e.g., to determine population data for the point of interest). Additionally, or alternatively, a user may define one or more geographic boundaries that include one or more road segments, such as in examples where vehicles are used to drop-off people, pick-up people, or park along the one or more road segments for people to go to a point of interest.

Additionally, or alternatively, a user may define a plurality of geographic boundaries that correspond to a point of interest. For example, a point of interest (e.g., a stadium) may have a plurality of regions (e.g., roads, parking lots, etc.), along which vehicles may travel to drop off people who are going to the point of interest. Therefore, to accurately count how many people are entering or leaving the point of interest, mechanisms disclosed herein may consider each of the plurality of geographic boundaries that correspond to the point of interest (e.g., by receiving sets of vehicle data from each of the plurality of geographic boundaries).

The machine learning model component 308 may contain (e.g., stored in a memory location corresponding to the machine learning model component 308), and/or train one or more machine learning models. For example, mechanisms disclosed herein may estimate a number of people at a point of interest based on a plurality of variables or factors. The machine learning model component 308 may be trained to count a number of passengers leaving vehicles based on a training set of vehicle data (e.g., a set of data that contains components similar to the vehicle data analysis component 118, discussed with respect to FIG. 2) and a ground truth set of data. The ground truth set of data may correspond to an observed actual number of passengers leaving vehicles (e.g., for each of the variables in the training set of vehicle data, a person may record a result of if, and if so, then how many, passengers exited a vehicle).

Accordingly, a trained machine learning model corresponding to the machine learning model component 308 may receive vehicle data, or one or more subsets thereof, (e.g., corresponding to one or more components of the vehicle data analysis component 118, discussed with respect to FIG. 2) to estimate a number of people within one or more geographic boundaries from which the vehicle data was received therefrom, and/or from which the vehicle data corresponds thereto.

In some examples, the machine learning model component 308 may be trained to count a number of passengers entering vehicles based on a training set of vehicle data (e.g., similar to the components of the vehicle data analysis component 118, discussed with respect to FIG. 2) and a ground truth set of data. The ground truth set of data may correspond to an observed actual number of passengers entering vehicles (e.g., for each of the variables in the training set of vehicle data, a person may record a result of if, and if so, then how many, passengers entered a vehicle). Accordingly, mechanisms disclosed herein may determine both how many people are entering a point of interest, and how many people are leaving a point of interest, to maintain a relatively accurate estimate of the number of people at a point of interest, based on vehicle data (e.g., for safety or logistical considerations that are of benefit to one or more users of mechanism described herein).

The one or more machine learning models discussed with respect to the machine learning model component 308 may be any type of machine learning model, such as, for example, a supervised machine learning model, an unsupervised machine learning model, and/or a semi-supervised machine learning model. Additionally, or alternatively, in some examples, a regression model may be used to output an estimated number of people at a POI, wherein weights are assigned to each of a plurality of variables. The plurality of variables may include one or more aspects of the vehicle sensor data (e.g., vehicle data 112) and/or the road data (e.g., road data 114) described earlier herein. Further, in some examples, a classification model may be used that determines whether an estimated number of people at a POI is one of low, moderate, or full, such as a low, moderate, or full capacity of a pre-determined capacity of the POI. The low, moderate, and full capacity levels may be configurable percentages of the pre-determined capacity of the POI.

The historical data component 310 may contain (e.g., stored in a memory location corresponding to the historical data component 310), and/or generate an indication of a number of people who travel to and/or from a point of interest, historically, at a given time, such as a specific time of day, day of the week, time of the year, scheduled event, etc. The historical data component 310 may be based on transit data, biking data, pedestrian data, scooter data, and/or other forms of transportation that one may take to/from a point of interest, other than vehicles (from which population information may otherwise be estimated using mechanisms disclosed herein). The historical data component 310 may update an estimated number of people (e.g., as determined by the machine learning model component 308) within one or more geographic boundaries (e.g., as determined by the geographic boundary generator component 306) corresponding to a point of interest (e.g., as determined by the point of interest identifier component 302). For example, the historical data component 310 may supplement the estimated number of people located at a point of interest using historical statistical analysis of travel methods corresponding to a point of interest, at a given time, other than vehicular travel.

Generally, the population estimation component 120 can identify a point of interest, identify one or more roads corresponding to the point of interest, generate one or more geographic boundaries corresponding to the point of interest, and estimate, using a machine learning model, a number of people at the point of interest (e.g., based on how many people are entering or leaving the point of interest, as determined via vehicle data). The number of people at the point of interest may be further determined based on historical data (e.g., pedestrian data, transit data, biker data, etc.) corresponding to the point of interest at a given time (e.g., day, year, specific event, etc.).

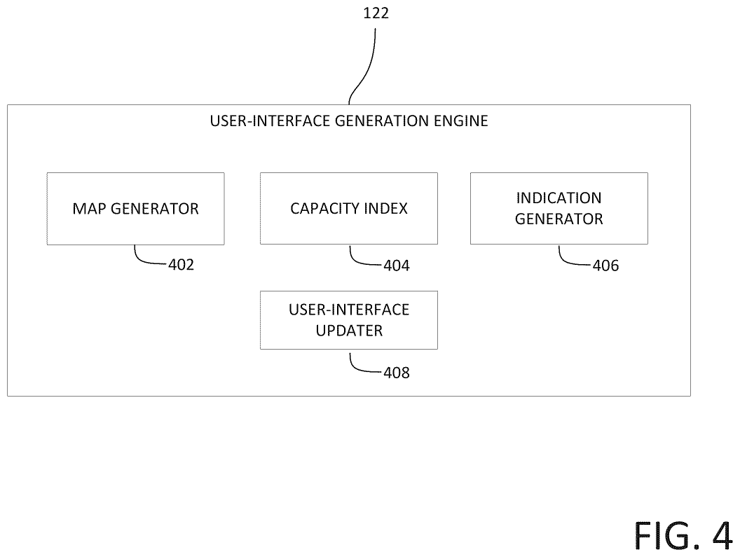

FIG. 4 illustrates a detailed schematic of the user-interface generation engine or component 122 of the example system 100. The user-interface generation component 122 includes a plurality of components or engines that implement various aspects of the user-interface generation component 122. For example, the user-interface generation component 122 can include a map generator component 402, a capacity index component 404, an indication generator component 406, and/or a user-interface updater component 408.

The map generator component 402 may contain (e.g., stored in a memory location corresponding to the map generator component 402), and/or generate an indication of a map. The map may be located on a display screen of a computing device (e.g., computing device 102 of FIG. 1). The map may be a satellite map, a road map, a drawing of a map, a partial map, or any kind of map. The map may include one or more roads (e.g., based on road data source 108). Additionally, the map may include one or more points of interest or POIs. Additional features of maps that may be incorporated with mechanisms disclosed herein may be recognized by those of ordinary skill in the art.

The capacity index component 404 may contain (e.g., stored in a memory location corresponding to the capacity index component 404), and/or generate a capacity index. For example, the capacity index may be calculated as a ratio of an estimated number of people (e.g., corresponding to a point of interest) to a capacity (e.g., of the point of interest). In some examples, the capacity index may be the estimated number of people divided by the capacity. Each point of interest (e.g., as identified by the point of interest identifier 302 of FIG. 3) may have a capacity. The capacity may be a pre-defined number of people that can be located at the point of interest based on one or more of a safety policy or physical space limitations. For example, a capacity of a point of interest based on a safety policy may be defined by fire codes, health guidelines, building policy limitations, and/or other policy factors. On the other hand, physical space limitations may be defined by how many people can physically fit at, and/or in, the point of interest.

The indication generator component 406 may contain (e.g., stored in a memory location corresponding to the indication generator component 406), and/or generate one or more indications corresponding to one or more capacity indexes (e.g., as calculated or otherwise determined by the capacity index 404). The one or more indications may be visual indications and/or audio indications. In some examples, the one or more indications may differ, based on the capacity index to which the one or more indications correspond.

In some examples, a first indication may correspond to the capacity index being less than a first threshold, a second indication may correspond to the capacity index being greater than the first threshold and less than a second threshold, and a third indication may correspond to the capacity index being greater than the second threshold. It should be recognized that in some examples there may be any number of indications and/or any number of thresholds based on which the indications are determined. Each of first, second, and third indications may be different. For example, the indications may be different colors, patterns, shapes, icons, sizes, brightness, contrast, animations, etc.

The user-interface updater component 408 may contain (e.g., stored in a memory location corresponding to the user-interface updater component 408), and/or generate one or more intervals at which one or more components of the user-interface generation component 122 are updated. The one more intervals may be regular intervals or irregular intervals. For example, a map (e.g., generated by the map generator component 402) may periodically be updated with new indicators (e.g., generated by the indication generator 406) based on updated capacity indexes (e.g., calculated by the capacity index 404, based on an updated estimated number of people at, and/or capacity of, a point of interest).

Generally, the user-interface generation component 122 provides improved user engagement through a user-interface (e.g., of a mapping software or application). User-interfaces generated in accordance with mechanisms disclosed herein may be periodically updated to provide an indication of a capacity index of a point of interest, such as via a map of the user-interface that may be shown on a display screen of a computing device. Therefore, one or more users can easily be informed, via one or more components of the user-interface generation component, when a point of interest has a relatively large capacity index or a relatively small capacity index, such that appropriate logistical travel decisions (e.g., which way to travel to make it home in time for dinner, by avoiding POIs with relatively large capacity indexes) and/or appropriate safety protocols (e.g., evacuations of POIs that have relatively large capacity indexes) can be made.

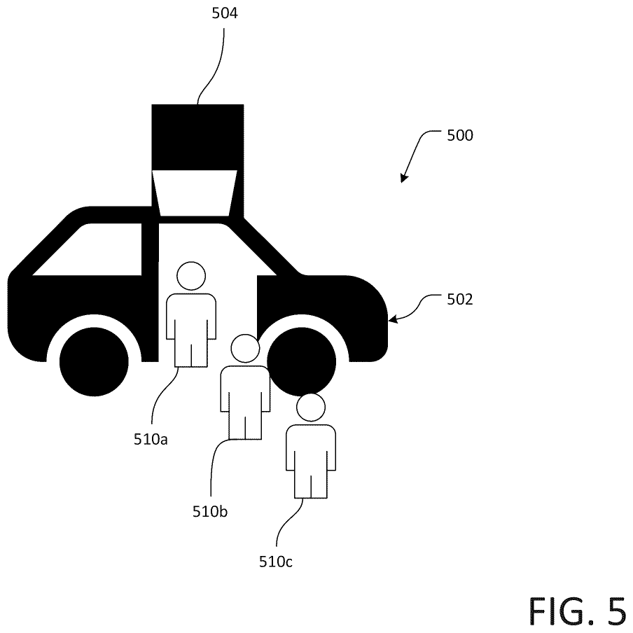

FIG. 5 illustrates an example use-case 500 of some mechanisms disclosed herein. For example use-case 500 includes a vehicle or car 502 with a vehicle door 504 and a plurality of people 510, such as first person 510a, a second person 510b, and a third person 510c. The vehicle 502 may include a plurality of sensors (not shown) from which data may be collected therefrom. For example, the vehicle 502 may include one or more sensors that detect a number of doors (e.g., door 504) open on the vehicle 502, which door (e.g., door 504) is open on the vehicle 502, a duration for which a door (e.g., door 504) is open on the vehicle 502, a duration for which the vehicle 502 is stopped, a change in seatbelt status on one or more seatbelts within the vehicle 502, weather around the vehicle 502, and/or a number of seats that are occupied within the vehicle 502. Each of the plurality of sensors may send or store data to the vehicle data analysis engine 118, discussed with respect to FIG. 2.

Mechanisms disclosed herein may estimate how many people enter and/or leave the vehicle 502. For example, the use-case 500 may show the first, second, and third person 510a, 510b, or 510c exiting the vehicle 502 at, or to go to, a point of interest. Alternatively, the use-case 500 may show the first, second, and third person 510a, 510b, or 510c entering the vehicle 504 at, or having left, a point of interest. Sensor data collected from the vehicle 504 may be able to determine not only that the first, second, and third person 510a, 510b, 510c are entering or leaving the vehicle 502, but also whether the first, second, and third person 510a, 510b, 510c are entering or leaving the vehicle 502.

For example, still referring to the use-case 500, if the door 504 of the vehicle 502 was opened from the inside, then the people 510 may arriving at a point of interest, and therefore an estimate of the number of people at the point of interest should increase. Alternatively, if the door 504 of the vehicle 502 was opened from the outside, then the people 510 may be leaving the point of interest, and therefore an estimate of the number of people at the point of interest should decrease. A duration for which the door 504 is opened and/or a duration for which the vehicle 502 is stopped may be used to determine that all three of the people 510 entered/exited the vehicle 502. In some examples, fewer than three people or greater than three people may enter/exit the vehicle 502 based on longer or shorter durations of time.

Still referring to the use-case 500, if three seat belts (not shown) were recently removed, based on vehicle data, then it may be determined that the three people 510 are exiting the vehicle 502 (thereby increasing an estimated number of people at a point of interest). Alternatively, if three seat belts are subsequently put on, then it may be determined that the three people are entering the vehicle 502 (thereby decreasing an estimated number of people at a point of interest). Similarly, if three seats (not shown) of the vehicle 502) were recently unoccupied, based on vehicle data, then it may be determined that the three people 510 are exiting the vehicle 502 (thereby increasing an estimated number of people at a point of interest). Alternatively, if three seat are subsequently occupied, then it may be determined that the three people are entering the vehicle 502 (thereby decreasing an estimated number of people at a point of interest).

Additional, and/or alternative examples in accordance with mechanisms described herein may be recognized by those of ordinary skill in the art. For example, different vehicles may be used with mechanisms described herein that include a different number of doors, additional and/or alternative sensors, greater or fewer passengers, etc., than those described with respect to the example use-case 500.

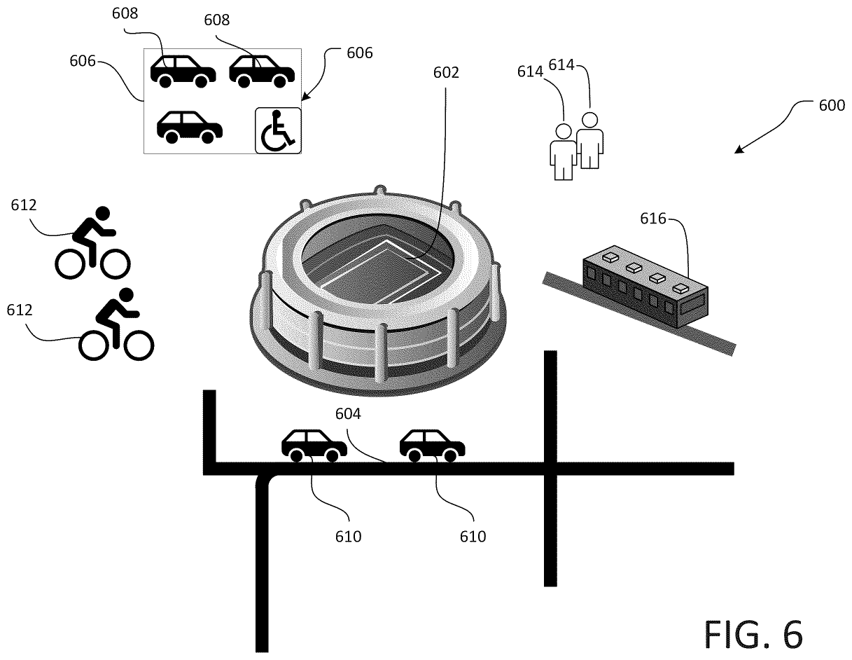

FIG. 6 illustrates an example use-case 600 of some mechanisms described herein. The use-case 600 includes a point of interest 602 (e.g., a stadium) at which mechanisms disclosed herein may be used to determine an estimated number of people, based on vehicle data. The point of interest 602 is surrounded by one or more roads 604. The point of interest 602 has a parking lot 606 in which a first set of vehicles 608 are located. A second set of vehicles 610 may be located along the one or more roads 604 that correspond to (e.g., are adjacent to and/or lead up to the point of interest 602). The use-case 600 further includes one or more bikers 612, one more pedestrians 614, and one or more transit options 616 (e.g., trains) carrying people that are all going to the point of interest 602.

The first set of vehicles 608 and the second set of vehicles 610 may each include a plurality of sensors from which respective sets of vehicle data are received (e.g., vehicle data 112). Further, the point of interest 602 may be identified using the point of interest identifier 302 (see FIG. 3) and the one or more roads 604 may be identified using the road identifier 304 (see FIG. 3).

According to mechanisms described herein, one or more geographic boundaries may be defined that encompass and/or correspond to the point of interest 602 (e.g., using the geographic boundary generator 306). The one or more geographic boundaries may be a single geographic boundary that is defined around the point of interest 602. For example, the single geographic boundary may be a polygonal shape with a geometric center thereof defined at a center of the point of interest (e.g., a geometric center, or a center that is both half of a latitudinal and half of a longitudinal range corresponding to the point of interest). Alternatively, the single geographic boundary may be a polygonal or non-polygonal shape with a geometric center thereof defined offset from the center of the point of interest. In some examples, the geographic boundary may have an outer diameter and an inner diameter, such that the geographic boundary encompasses, but does not include the point of interest itself, such as in examples where the point of interest is surrounded by a parking lot, but vehicles are not allowed to enter the point of interest. In some examples, the geographic boundary may encompass one or more portions of the plurality of roads 604.

Alternatively, the one or more geographic boundaries may be a plurality of geographic boundaries. For example, a first geographic boundary may encompass the parking lot 606, a second geographic boundary may encompass the point of interest 602, and/or a third geographic boundary may encompass one or more portions of the one or more roads 604. In some examples, based on a road identifier, such as the road identifier 304 (see FIG. 3), one or more roads from the one or more roads 604 may be determined to correspond to the point of interest 602. For example, people may get dropped-off from, picked-up at, or park at one or more of the one or more roads 604 to go to the point of interest 602. Accordingly, it may be beneficial to include a geographic boundary along each of the one or more roads 604 along which vehicles (e.g., vehicles 610) may be located that people are entering or exiting therefrom to go to the point of interest 602. Each of the plurality of geographic boundaries may include their own respective sets of vehicle data because they have different vehicles sets of vehicles (e.g., vehicles 610 or vehicles 608) disposed therein.

Further, while mechanism disclosed herein use vehicle data (e.g., from vehicles 610 or vehicles 608) to estimate the number of people at a point of interest (e.g., point of interest 602), the estimated number of people at the point of interest 602 may be updated based on historical data (e.g., using the historical data component 310). For example, based on a statistical analysis of historical data, it may be determined, for a given time (e.g., time of day, day of the year, season, event, etc.) how many people are statistically likely to enter and/or exit a point of interest by walking, biking, scootering, taking a train, etc. For example, in addition to estimating the number of people at the point of interest 602 based on the vehicles 608 and 610, mechanisms disclosed herein may use historical data to further estimate the number of people at the point of interest 602 to include the one or more bikers 612, the one or more pedestrians 614, and the one or more trains 616.

Accordingly, an accurate estimation of the number of people at the point of interest 602 may be determined without the need to request ticket and/or reservation information from an operator of the point of interest 602. Therefore, people may have an improved ability to plan travel logistics around the point of interest 602 (e.g., because of traffic corresponding to the estimated number of people thereat), and/or safety officials (e.g., firefighters, paramedics, police officers, etc.) can appropriately execute safety protocols, if needed, based on an estimated number of people at the point of interest 602.

FIG. 7 illustrates an example method 700 of estimating a number of people corresponding to a point of interest, according to some aspects described herein. In examples, aspects of method 700 are performed by a device, such as computing device 102 and/or server 104, discussed above with respect to FIG. 1.

Method 700 begins at operation 702 wherein vehicle data (e.g., vehicle data 112) is received that corresponds to one or more geographic boundaries (e.g., generated by the geographic boundary generator 306). The vehicle data may be received from a plurality of vehicles. Further, the vehicle data may be received in real time or near real time. For example, each of a plurality of vehicles may include sensors that generate vehicle data, and the vehicle data may be communicated to a computing device (e.g., computing device 102) and/or a network (e.g., network 110). In some examples, road data may further be received (e.g., road data 114), such as to assist in determining the location of one or more geographic boundaries.

The one or more geographic boundaries correspond to a point of interest. For example, the point of interest may be the point of interest 602. Additionally, or alternatively, the point of interest may be a point of interest identified by the point of interest identifier 304. In some examples, the one or more geographic boundaries may encompass (e.g., surround) the point of interest. As discussed earlier herein, the point of interest may be, for example a venue (stadium, conference hall, concert hall, etc.), a restaurant, a hotel, or a park. The one or more geographic boundaries may include one or more road segments (e.g., of roads 604 and/or other roads identified using the road data 114). The one or more geographic boundaries may be a plurality of geographic boundaries that each correspond to a respective set of vehicle data for vehicles disposed therewithin.

At operation 704, from the vehicle data that is received from operation 702, a first subset of data is extracted. The first subset of data may correspond to door sensor information (e.g., a number of doors open on a vehicle, which doors are open on a vehicle, a duration for which a vehicle door is open, a duration for which a vehicle is stopped, etc.). In some examples, a second subset of data may be extracted that corresponds to a change in seatbelt status. In some examples a third subset of data may be extracted that corresponds to weather information. Further, in some examples, a fourth subset of data may be extracted that corresponds to a number of seats that are occupied in each of a plurality of vehicles.

At determination 706 it is determined if there is an estimated number of people within the one or more geographic boundaries. For examples, if no doors have been opened on one or more vehicles, then there may be no estimated number of people (or zero estimated number of people) who have entered the one or more geographic boundaries, based on the vehicle data. Alternatively, if one or more vehicle doors have been opened, one or more seatbelts have been unbuckled, and/or there is a change in a number of vehicle seat that are occupied, etc., then it may be determined that there is an estimated number of people within the one or more geographic boundaries, based on the vehicle data.

If it is determined that there is not an estimated number of people within the one or more geographic boundaries, based on the vehicle data, flow branches “NO” to operation 708, where a default action is performed. For example, the vehicle data may have an associated pre-configured action. In other examples, method 700 may comprise determining whether the vehicle data has an associated default action, such that, in some instances, no action may be performed as a result of the received vehicle data. Method 700 may terminate at operation 708. Alternatively, method 700 may return to operation 702 to provide an iterative loop of receiving vehicle data corresponding to one or more geographic boundaries that correspond to a point of interest and determining whether there exists an estimated number of people within the one or more geographic boundaries, based on the vehicle data.

If however, it is determined that there is an estimated number of people within the one or more geographic boundaries that correspond to the point of interest, flow instead branches “YES” to operation 710, where, based on the first subset of data, the estimated number of people within the one or more geographic boundaries may be determined. Additionally, or alternatively, the estimated number of people within the one or more geographic boundaries may be determined based on one or more of the first, second, third, or fourth subsets of data described earlier herein.

The estimated number of people within the one or more geographic boundaries may be determined, during a specified period of time. For example, an estimated number of people at a point of interest may be set to zero at a start time when it is known or assumed that no people are at the point of interest. Additionally, or alternatively, the estimated number of people may be set to a known value of people at the start time. From that time, an estimated number of people may increase, based on vehicle data, as people arrive at the point of interest (e.g., by vehicles). Additionally, or alternatively, the estimated number of people may decrease, based on vehicle data, as people leave the point of interest (e.g., in vehicles).

The determining of the estimated number of people may include inputting the first subset of data into a trained machine learning model (e.g., a machine learning model stored, generated, and/or trained by the machine learning model component 308, discussed earlier herein with respect to FIG. 3). The estimated number of people within the geographic boundary may be received from the trained machine learning model. In some examples, one or more of the first, second, third, or fourth subsets of data may be input into the trained machine learning model, for an estimated number of people within the geographic boundaries to be determined, by the trained machine learning model, based on the one or more of the first, second, third, or fourth subsets of data.

Further, in some examples, historical data may be received that corresponds to transit data (e.g., trains), biking data, and pedestrian data for a point of interest. The historical data may correspond to a specific time or time-range for a given day of the week, day of the year, time of day, event at a point of interest, etc. Further, the historical data may be time-based and/or geographically-based to supplement an estimated number of people within the one or more geographic boundaries that is calculated based on vehicles data. Therefore, the estimated number of people determined at operation 710 may further be determined by, or updated based on, the historical data.

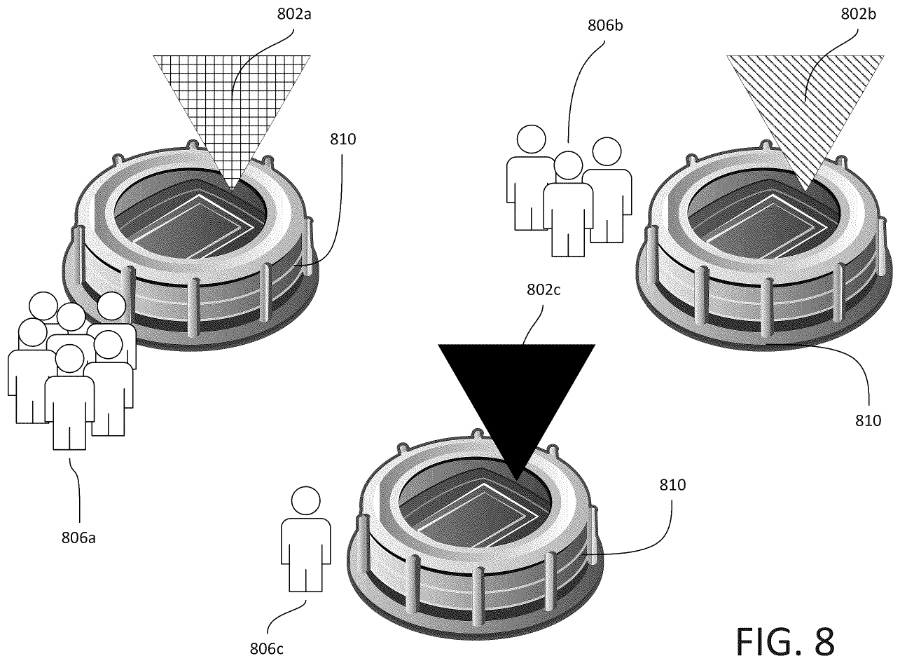

Flow advances to operation 712, wherein an indication is generated that corresponds to the estimated number of people within the one or more geographic boundaries. In some examples, the indication may be a visual indication, as will be discussed further herein with respect to FIGS. 8 and 9. Additionally, or alternatively, the indication may be an audio indication. In some examples, the indication may be an alert (e.g., an emergency or safety alert). The alert may be transmitted to one or more safety officials, such that a safety protocol (e.g., an inclement weather protocol, evacuation protocol, etc.) may be carried out, based on the estimated number of people at a point of interest.

Generally, mechanisms disclosed herein allow for an estimated number of people within one or more geographic boundaries that correspond to a point of interest to be determined, based on vehicle data. The ability to estimate a number of people within one or more geographic boundaries may be beneficial for safety officials to effectively execute safety protocols (e.g., inclement weather protocols, evacuation protocols, etc.). Further, the ability to estimate a number of people within the one or more geographic boundaries may be helpful for individuals who are planning travel logistics, around the point of interest to which the one or more geographic boundaries correspond, such that the individual's travel may not be delayed (e.g., by traffic or crowds corresponding to the estimated number of people). Further advantages may be apparent to those of ordinary skill in the art.

Method 700 may terminate at operation 712. Alternatively, method 700 may return to operation 702 (or any other operation from method 700) to provide an iterative loop, such as of receiving vehicle data corresponding to one or more geographic boundaries that correspond to a point of interest, and generating an indication corresponding to an estimated number of people within the one or more geographic boundaries, and thereby an estimated number of people that may be at the point of interest.

FIG. 8 illustrates an example one or more indicators, such as a first indicator 802a, a second indicator 802b, and third indicator 802c, of one or more numbers (e.g., estimated numbers) of people, such as a first number of people 806a, a second number of people 806b, and a third number of people 806c, corresponding to a point of interest 810. The first indicator 802a, the second indicator 802b, and the third indicator 802c may each be visual indicators. Additionally, or alternatively, the first indicator 802a, the second indicator 802b, and the third indicator 802c may each be audio indicators.

Each of the plurality of indicators 802a, 802b, 802c may be differentiated from each other based on different colors, icons, shapes, text, sizes, animations, patterns, brightness, contrasts, or other visually differentiating characteristics. Additionally, or alternatively, each of the plurality of indicators 802a, 802b, 802c, may be differentiated from each other based on different audio sounds, such as different pitches, tones, vocals, frequencies, or other auditory differentiating characteristics.

The point of interest 810 may have a capacity that is pre-defined by a user or system. For example, the capacity may be predefined based on a safety policy and/or a physical space limitation. The safety policy may be defined by fire codes, health guidelines, building policy limitations, a number of available seats, and/or other policy factors. On the other hand, physical space limitations may be defined by how many people can physically fit at, in, and/or around, the point of interest.

Based on the capacity of the point of interest and a number of people at the point of interest (e.g., the first number of people 806a, the second number of people 806b, the third number of people 806c), a capacity index may be calculated. The capacity index may be a ratio of the estimated number of people at the point of interest to the capacity of the point of interest. Each of the one or more visual indicators 802a, 802b, 802c may be generated, based on the capacity index. In some examples, one or more of the visual indicators 802a, 802b, 802c may be pie charts, histograms, or any other type of plot and/or graph that represent the capacity index.

In the example of FIG. 8, the first number of people 806a at the point of interest 810 may be greater than a first threshold, therefore the first indicator 802a is generated. The second number of people 806b at the point of interest 810 may be less than the first threshold, but greater than a second threshold, therefore the second indicator 802b is generated. The third number of people 806c at the point of interest 810 may be less than the second threshold, therefore the third indicator 802c is generated. While the present example includes three thresholds, it should be recognized that there may be any number of threshold at varying configurable values, specified by a system and/or user.

As may be recognized by the example of FIG. 8, as an estimated number of people (e.g., number of people 806a, 806b, 806c) are received that correspond to the point of interest 810, a corresponding capacity index may be calculated. Further, based on the capacity index, a corresponding indicator (e.g., indicator 802a, 802b, 802c) may be generated. The estimated number of people 806a, 806b, 806c may each be calculated using mechanisms described earlier herein, such as based on vehicle data. Therefore, the estimated number of people 806a, 806b, 806c may be an estimated number of people who have exited vehicles and/or an estimated number of people outside of vehicles.

As discussed earlier herein, the estimated number of people corresponding to a point of interest (e.g., based on one or more geographic boundaries corresponding to the point of interest) may be updated as people exit vehicles and/or as people enter vehicles, such that the estimated number of people may increase or decrease. Accordingly, a capacity index may similarly be updated to increase or decrease, based on a relative change (e.g., increase or decrease) in the estimated number of people. Therefore, indicators (e.g., indicators 802a, 802b, 802c) corresponding to the capacity indexes may be generated, re-generated, and/or replace each other, depending on updated values of capacity indexes.

FIG. 9 illustrates an example method 900 of generating an indicator of an estimated number of people corresponding to a point of interest, according to some aspects described herein. In examples, aspects of method 900 are performed by a device, such as computing device 102 and/or server 104, discussed above with respect to FIG. 1.

Method 900 begins at operation 902, wherein an estimated number of people within one or more geographic boundaries is received. The estimated number of people may correspond to a point of interest (e.g., they may be located, in, at, and/or around the point of interest). In some examples, a plurality of estimated number of people corresponding to respective points of interest of a plurality of points of interest are received. The estimated number of people may be generated based on mechanisms disclosed herein, such as those described with respect to FIGS. 1-7. For example, the estimated number of people may be generated based on vehicle data, and be an estimated number of people outside of vehicles and/or an estimated number of people who exited one or more vehicles. Additionally, or alternatively, the estimated number of people received may be based on other mechanisms, such as ticket data, reservation data, camera data at a point of interest, etc. Further, the geographic boundaries may be similar to the geographic boundaries described earlier herein with respect to FIG. 6.

At determination 904, it is determined if there is a point of interest corresponding to the one or more geographic boundaries of operation 902. For examples, based on road data (e.g., road data 114), it may be determined if a point of interest can be identified, give one or more geographic boundaries (e.g., via the point of interest identifier 302 of FIG. 3). If the one more geographic boundaries do not have a corresponding point of interest, then a capacity of a corresponding point of interest may not exist. However, if the one or more geographic boundaries do have a corresponding point of interest, then a capacity of the point of interest may be able to be determined and/or received for further processing.

If it is determined that there is not a point of interest corresponding to the one or more geographic boundaries, flow branches “NO” to operation 906, where a default action is performed. For example, the one or more geographic boundaries may have an associated pre-configured action. In other examples, method 900 may comprise determining whether the one or more geographic boundaries have an associated default action, such that, in some instances, no action may be performed as a result of the received vehicle data. Method 900 may terminate at operation 906. Alternatively, method 900 may return to operation 902 to provide an iterative loop of receiving an estimated number of people within one or more geographic boundaries and determining if a point of interest exists that corresponds to the one or more geographic boundaries.

If however, it is determined that there is a point of interest that corresponds to the one or more geographic boundaries, flow instead branches “YES” to operation 908, wherein a capacity for the point of interest corresponding to the one or more geographic boundaries is received. In some examples, a user may provide the capacity for the point of interest, such as, for example, via a user-interface of a computing device (e.g., computing device 102). Additionally, or alternatively, the capacity of the point of interest may be received from a database, a server, a computing device, etc. In examples where a plurality of estimated number of people are received corresponding to a respective point of interest, a capacity may be received for each of the respective points of interests (e.g., each of a plurality of points of interest).

The capacity may be predefined based on a safety policy and/or a physical space limitation. The capacity may be measured in a number of people (e.g., a restaurant may have a capacity of 100 people). The safety policy may be defined by fire codes, health guidelines, building policy limitations, a number of available seats, and/or other policy factors. On the other hand, physical space limitations may be defined by how many people can physically fit at, in, and/or around, the point of interest.

Flow advances to operation 910, wherein a capacity index is calculated. The capacity index may be calculated or otherwise generated by the capacity index component 404 of FIG. 4. The capacity index may be a ratio of the one or more estimated number of people of operation 902 to the capacity of operation 908. Specifically, the capacity may be the estimated number of people divided by the capacity. Therefore, for example, if the estimated number of people at a point of interest are 50 people and the capacity of the point of interest is 100, then the capacity index may be 0.50 or 50%. In some examples, a plurality of capacity indexes may be calculated based on a plurality of estimated number of people that are each located at and/or in a respective point of interest from a plurality of points of interest.

Flow advances to operation 912, wherein an indicator is generated, based on the capacity index. The indicator may be generated by the indication generator component 406 of FIG. 4. The indicator may be similar to one or more of the indicators 802a, 802, 802c described with respect to FIG. 8. In some examples, the indicator may be displayed on a map, such as a map generated by the map generator component 402 of FIG. 4.

In some examples, the estimated number of people, the capacity index, and the indicator may be updated periodically. For example, the user-interface updater 408 of FIG. 4 may update a user-interface of a computing device (e.g., computing device 102) at some regular or irregular interval to display (e.g., for visual indicators) and/or emit (e.g., for audio indicators) the generated indicator of operation 912.

Generally, mechanisms disclosed herein allow for improved user-engagement (e.g., via a user-interface) by providing indicators that correspond to a capacity index of a point of interest. The ability to quickly recognize whether a point of interest is relatively or relatively empty, may impact a user's decision to go to, or even to travel around, the point of interest. Further, varying safety protocols may be implemented corresponding to varying indicators that are generated. Therefore, safety officials may choose to rely on indicators generated using methods described herein to implement one or more safety protocols at a point of interest. Further advantages may be apparent to those of ordinary skill in the art.

Method 900 may terminate at operation 912. Alternatively, method 900 may return to operation 902 (or any other operation from method 900) to provide an iterative loop, such as of receiving an estimated number of people within one or more geographic boundaries, and generating an indication corresponding to a calculated capacity index of a point of interest corresponding to the one or more geographic boundaries.

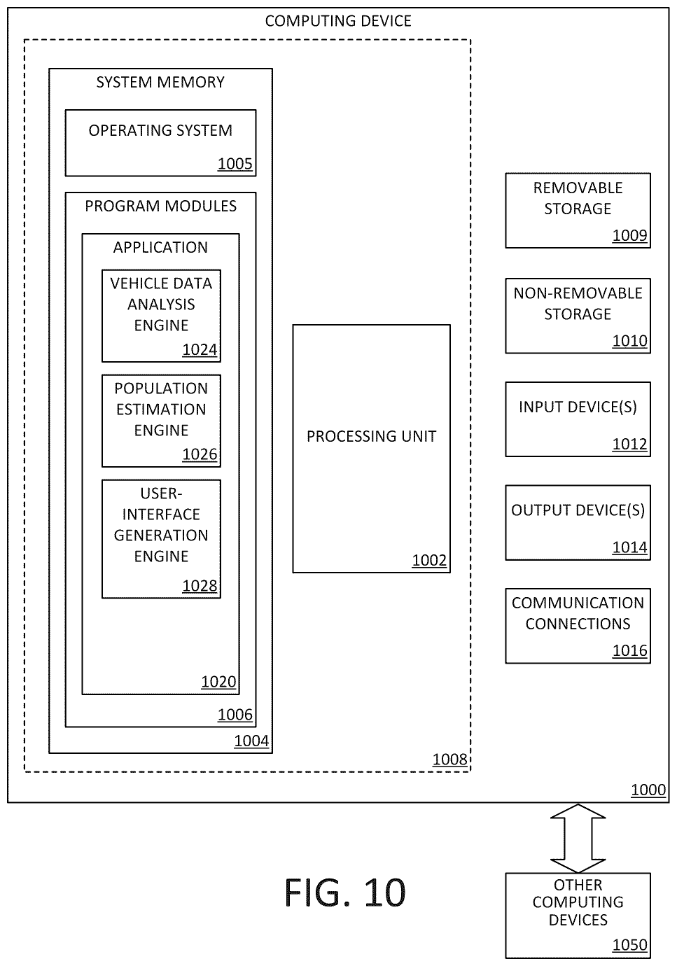

FIGS. 10-13 and the associated descriptions provide a discussion of a variety of operating environments in which aspects of the disclosure may be practiced. However, the devices and systems illustrated and discussed with respect to FIGS. 10-13 are for purposes of example and illustration and are not limiting of a vast number of computing device configurations that may be utilized for practicing aspects of the disclosure, described herein.

FIG. 10 is a block diagram illustrating physical components (e.g., hardware) of a computing device 1000 with which aspects of the disclosure may be practiced. The computing device components described below may be suitable for the computing devices described above, including computing device 102 in FIG. 1. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories.

The system memory 1004 may include an operating system 1005 and one or more program modules 1006 suitable for running software application 1020, such as one or more components supported by the systems described herein. As examples, system memory 1004 may store vehicle data analysis engine or component 1024, population estimation engine or component 1026, and/or user-interface generation engine or component 1028. The operating system 1005, for example, may be suitable for controlling the operation of the computing device 1000.

Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., application 1020) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

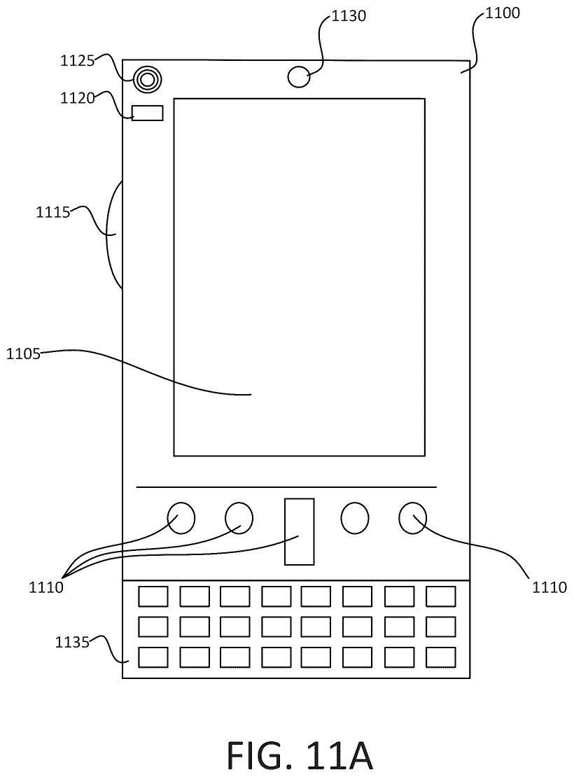

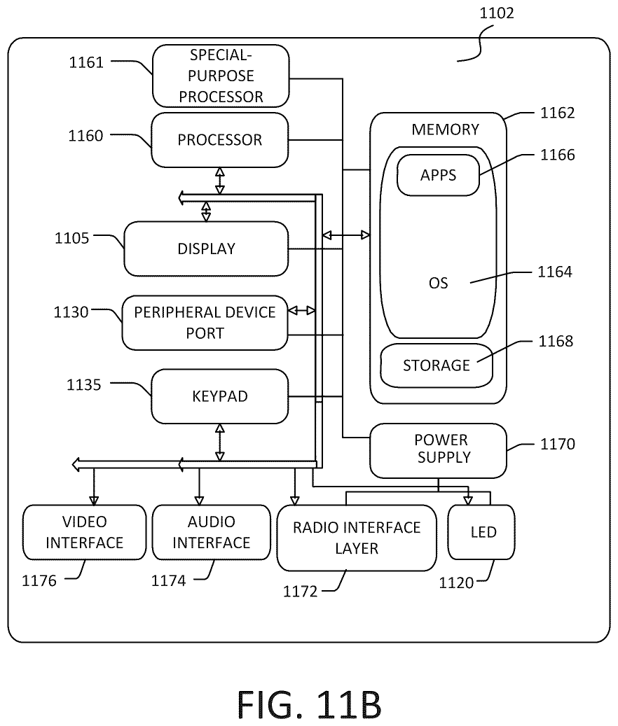

FIGS. 11A and 11B illustrate a mobile computing device 1100, for example, a mobile telephone, a smart phone, wearable computer (such as a smart watch), a tablet computer, a laptop computer, and the like, with which some aspects of the disclosure may be practiced. In some aspects, the client may be a mobile computing device. With reference to FIG. 11A, one aspect of a mobile computing device 1100 for implementing the aspects is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The one or more input buttons 1110 may be “soft” buttons that are generated on the touch screen display. The display 1105 of the mobile computing device 1100 may also function as an input device (e.g., a touch screen display).

If included, an optional side input element 1115 allows further user input. The side input element 1115 may be a rotary switch, a button, or any other type of manual input element. In alternative aspects, mobile computing device 1100 may incorporate more or less input elements. For example, the display 1105 may not be a touch screen in some examples.

In yet another alternative example, the mobile computing device 1100 is a portable phone system, such as a cellular phone. The mobile computing device 1100 may also include an optional keypad 1135. Optional keypad 1135 may be a physical keypad or a “soft” keypad generated on the touch screen display.

In various examples, the output elements include the display 1105 for showing a graphical user interface (GUI), a visual indicator 1120 (e.g., a light emitting diode), and/or an audio transducer 1125 (e.g., a speaker). In some aspects, the mobile computing device 1100 incorporates a vibration transducer for providing the user with tactile feedback. In yet another aspect, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one aspect of a mobile computing device. That is, the mobile computing device 1100 can incorporate a system (e.g., an architecture) 1102 to implement some aspects. In some examples, the system 1102 is implemented as a “smart phone” capable of running one or more applications (e.g., browser, e-mail, calendaring, contact managers, messaging clients, games, and media clients/players). In some aspects, the system 1102 is integrated as a computing device, such as an integrated personal digital assistant (PDA) and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as e-mail or other messages used by an e-mail application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100 described herein (e.g., a vehicle data analysis engine, a population estimation engine, a user-interface generation engine, etc.).

The system 1102 has a power supply 1170, which may be implemented as one or more batteries. The power supply 1170 might further include an external power source, such as an AC adapter or a powered docking cradle that supplements or recharges the batteries.

The system 1102 may also include a radio interface layer 1172 that performs the function of transmitting and receiving radio frequency communications. The radio interface layer 1172 facilitates wireless connectivity between the system 1102 and the “outside world,” via a communications carrier or service provider. Transmissions to and from the radio interface layer 1172 are conducted under control of the operating system 1164. In other words, communications received by the radio interface layer 1172 may be disseminated to the application programs 1166 via the operating system 1164, and vice versa.

The visual indicator 1120 may be used to provide visual notifications, and/or an audio interface 1174 may be used for producing audible notifications via the audio transducer 1125. In the illustrated example, the visual indicator 1120 is a light emitting diode (LED) and the audio transducer 1125 is a speaker. These devices may be directly coupled to the power supply 1170 so that when activated, they remain on for a duration dictated by the notification mechanism even though the processor 1160 and/or special-purpose processor 1161 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone to receive audible input, such as to facilitate a telephone conversation. In accordance with aspects of the present disclosure, the microphone may also serve as an audio sensor to facilitate control of notifications, as will be described below. The system 1102 may further include a video interface 1176 that enables an operation of an on-board camera 1130 to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio interface layer 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio interface layer 1172 or via a distributed computing network. Similarly, such data/information may be readily transferred between computing devices for storage and use according to well-known data/information transfer and storage means, including electronic mail and collaborative data/information sharing systems.

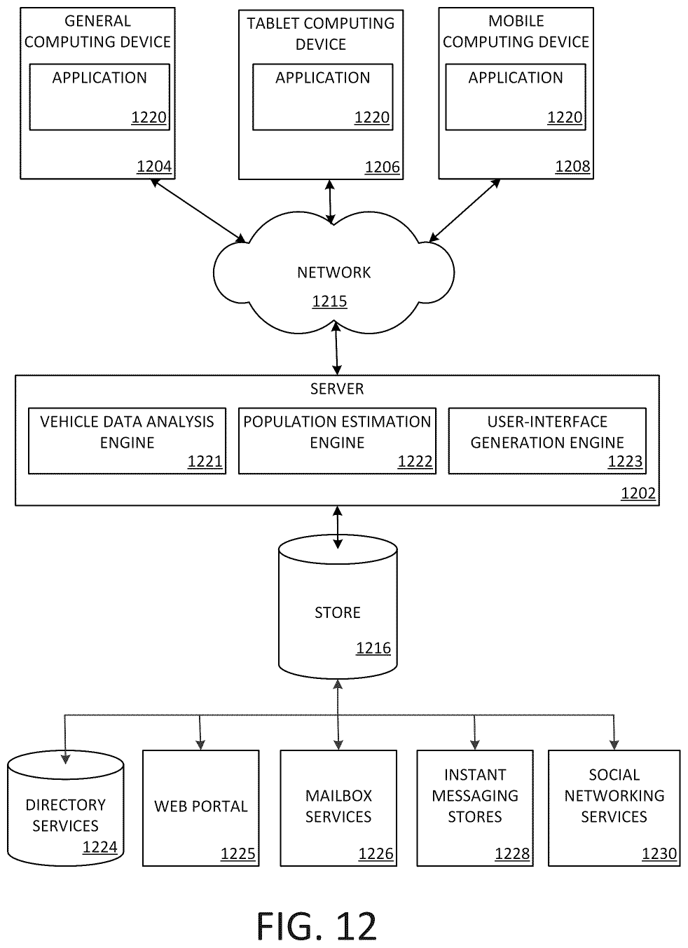

FIG. 12 illustrates one aspect of the architecture of a system for processing data received at a computing system from a remote source, such as a personal computer 1204, tablet computing device 1206, or mobile computing device 1208, as described above. Content displayed at server device 1202 may be stored in different communication channels or other storage types. For example, various documents may be stored using a directory service 1224, a web portal 1225, a mailbox service 1226, an instant messaging store 1228, or a social networking site 1230.

An application 1220 (e.g., similar to the application 1020) may be employed by a client that communicates with server device 1202. Additionally, or alternatively, vehicle data analysis engine 1221, population estimation engine 1222, and/or user-interface generation engine 1223 may be employed by server device 1202. The server device 1202 may provide data to and from a client computing device such as a personal computer 1204, a tablet computing device 1206 and/or a mobile computing device 1208 (e.g., a smart phone) through a network 1215. By way of example, the computer system described above may be embodied in a personal computer 1204, a tablet computing device 1206 and/or a mobile computing device 1208 (e.g., a smart phone). Any of these examples of the computing devices may obtain content from the store 1216, in addition to receiving graphical data useable to be either pre-processed at a graphic-originating system, or post-processed at a receiving computing system.

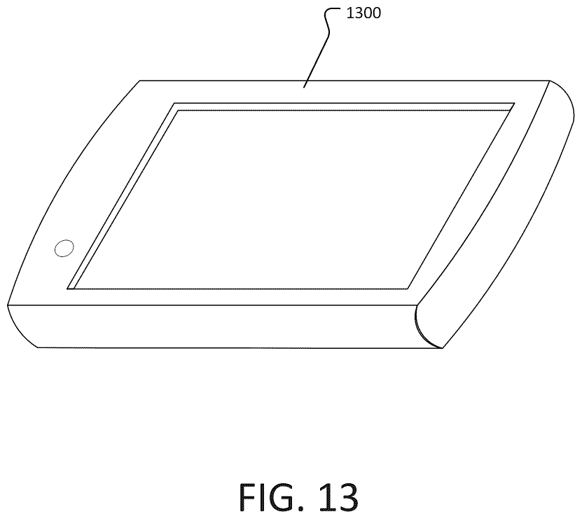

FIG. 13 illustrates an exemplary tablet computing device 1310 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the present disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, the method comprising:
receiving a first estimated number of people who have exited vehicles within a geographic boundary;
receiving a capacity for a point of interest corresponding to the geographic boundary;
calculating a capacity index, the capacity index being a ratio of the first estimated number of people to the capacity;
generating a first visual indicator, based on the capacity index; and
displaying the first visual indicator on a map, based on a location of the point of interest.

2. The method of claim 1, further comprising:
receiving a second estimated number of people within the geographic boundary;
calculating a second capacity index, the second capacity index being a ratio of the second estimated number of people to the capacity;
generating a second visual indicator, based on the second capacity index; and
replacing the first visual indicator, on the map, with the second visual indicator.

3. The method of claim 2, wherein the first visual indicator comprises a first icon that includes a first color and the second visual indicator comprises a second icon that includes a second color.

4. The method of claim 2, further comprising:
receiving a third estimated number of people within the geographic boundary;
calculating a third capacity index, the third capacity index being a ratio of the third estimated number of people to the capacity;
re-generating the first visual indicator, based on the third capacity index; and
replacing the second visual indicator, on the map, with the first visual indicator.

5. The method of claim 2, further comprising:
receiving a third estimated number of people within the geographic boundary;
calculating a third capacity index, the third capacity index being a ratio of the third estimated number of people to the capacity;
generating a third visual indicator, based on the third capacity index; and
replacing the second visual indicator, on the map, with the third visual indicator.

6. The method of claim 5, wherein the third visual indicator comprises a third icon that includes a third color.

7. The method of claim 5, wherein the first visual indicator corresponds to the capacity index being less than a first threshold.

8. The method of claim 7, wherein the second visual indicator corresponds to the capacity index being greater than the first threshold and less than a second threshold.

9. The method of claim 8, wherein the third visual indicator corresponds to the capacity index being greater than the second threshold.

10. The method of claim 7, wherein each of the first threshold, second threshold, and third threshold are configurable values.

11. The method of claim 1, wherein the capacity is a pre-defined number of people that can be located at the point of interest based on one or more of: a safety policy or physical space limitations.

12. A method, the method comprising:
receiving a first estimated number of people, outside of vehicles, corresponding to a first point of interest;
receiving a second estimated number of people, outside of vehicles, corresponding to a second point of interest;
receiving a first capacity for the first point of interest and a second capacity for the second point of interest;
calculating a first capacity index for the first point of interest and a second capacity index for the second point of interest;
generating a first indicator, based on the first capacity index, and a second indicator, based on the second capacity index.

13. The method of claim 12, wherein the first capacity index is a ratio of the first estimated number of people to the first capacity, and wherein the second capacity index is a ratio of the second estimated number of people to the second capacity.

14. The method of claim 12, wherein the first and second indicators comprise audio indicators.

15. The method of claim 14, further comprising: displaying the first and second visual indicators on a map.

16. A method, the method comprising:
receiving an estimated number of people, outside of vehicles, within one or more geographic boundaries;
receiving a capacity for a point of interest corresponding to the one or more geographic boundaries;
calculating a capacity index, the capacity index being a ratio of the estimated number of people to the capacity;
generating a visual indicator, based on the capacity index,
wherein the estimated number of people, the capacity index, and the visual indicator are updated periodically.

17. The method of claim 16, wherein if the capacity index is greater than a pre-determined threshold, the generated visual indicator is a first visual indicator.

18. The method of claim 17, wherein if the capacity index is less than a pre-determined threshold, the generated visual indicator is a second visual indicator.

19. The method of claim 16, wherein the estimated number of people within the geographic boundary is calculated based on vehicle data.

20. A system, the system comprising:
at least one processor; and
memory storing instructions that, when executed by the at least one processor, causes the system to perform the method of claim 16.
